(19) United States
(12) Patent Application Publication
(10) Pub. No.: US 2025/0299354 A1
(43) Pub. Date: Sep. 25, 2025

(54) CONTROL APPARATUS, CONTROL METHOD, AND STORAGE MEDIUM

(71) Applicant: CANON KABUSHIKI KAISHA, Tokyo (JP)

(72) Inventor: TAKAYUKI JINNO, Kanagawa (JP)

(21) Appl. No.: 19/081,646

(22) Filed: Mar. 17, 2025

(30) Foreign Application Priority Data
Mar. 19, 2024 (JP) 2024-044104

(51) Int. Cl. G06T 7/586; G06T 7/00; G06T 7/90; H04N 23/74

(52) U.S. Cl. CPC G06T 7/586; G06T 7/0004; G06T 7/90; H04N 23/74; G06T 2207/10152

(57) ABSTRACT

A control apparatus includes at least one processor and at least one memory that is in communication with the at least one processor. The at least one memory stores instructions for causing the at least one processor and the at least one memory to acquire a first signal indicating activation timings of light sources synchronized with an imaging, activate a plurality of light sources among the activation timings of the light sources based on the first signal at a first timing, and output, to a lighting unit, a second signal for activating a light source different from the plurality of light sources at a second timing.

### BACKGROUND

### Field of the Disclosure

The present disclosure relates to a technique for inspecting objects.

### Description of the Related Art

As an appearance inspection technique for industrial products, there is a known method for detecting asperities on inspection surfaces. Japanese Patent Application Laid-Open No. 2015-232480 discloses a technique for compositing, using a photometric stereo method, a plurality of images obtained by imaging an inspection target object to determine from the composited image whether the inspection target object is good or bad.

Some types of industrial products are produced at high rates per unit time, which may result in a short time available for each inspection. If a plurality of light sources is activated one by one, the imaging time increases based on the number of light sources, and the time for the inspection process increases based on the number of images captured.

### SUMMARY

In view of this, embodiments of the present disclosure are directed to reducing the time taken for an inspection based on a captured image obtained by imaging an object.

According to an aspect of the present disclosure, a control apparatus includes at least one processor and at least one memory that is in communication with the at least one processor. The at least one memory stores instructions for causing the at least one processor and the at least one memory to acquire a first signal indicating activation timings of light sources synchronized with an imaging, activate a plurality of light sources among the activation timings of the light sources based on the first signal at a first timing, and output, to a lighting unit, a second signal for activating a light source different from the plurality of light sources at a second timing.

Further features of various embodiments will become apparent from the following description of exemplary embodiments with reference to the attached drawings.

### BRIEF DESCRIPTION OF THE DRAWINGS

FIGS. 1A to 1C are diagrams illustrating an external appearance and hardware configuration of an appearance inspection system according to a first exemplary embodiment.

FIG. 2 is a diagram illustrating a functional configuration of the appearance inspection system according to the first exemplary embodiment.

FIGS. 3A and 3B are diagrams illustrating an arrangement of light sources in a lighting apparatus according to the first exemplary embodiment.

FIG. 4 is a flowchart of a process of controlling activations of the light sources according to the first exemplary embodiment.

FIG. 5 is a diagram illustrating a correspondence between synchronization signals and activation timings of light sources according to the first exemplary embodiment.

FIG. 6 is a diagram illustrating an example of a user interface according to the first exemplary embodiment.

FIG. 7 is a flowchart of a process in an image processing system according to the first exemplary embodiment.

FIG. 8 is a diagram illustrating a hardware configuration of an appearance inspection system according to a second exemplary embodiment.

FIG. 9 is a diagram illustrating a functional configuration of the appearance inspection system according to the second exemplary embodiment.

FIG. 10 is a diagram illustrating a correspondence between synchronization signals and activation timings of light sources according to the second exemplary embodiment.

### DESCRIPTION OF THE EMBODIMENTS

Some exemplary embodiments will now be described with reference to the drawings. The following exemplary embodiments do not necessarily limit every embodiment. Furthermore, not all of the combinations of features in the exemplary embodiments are used in solving means of every embodiment.

### Appearance and Hardware Configuration of Appearance Inspection System

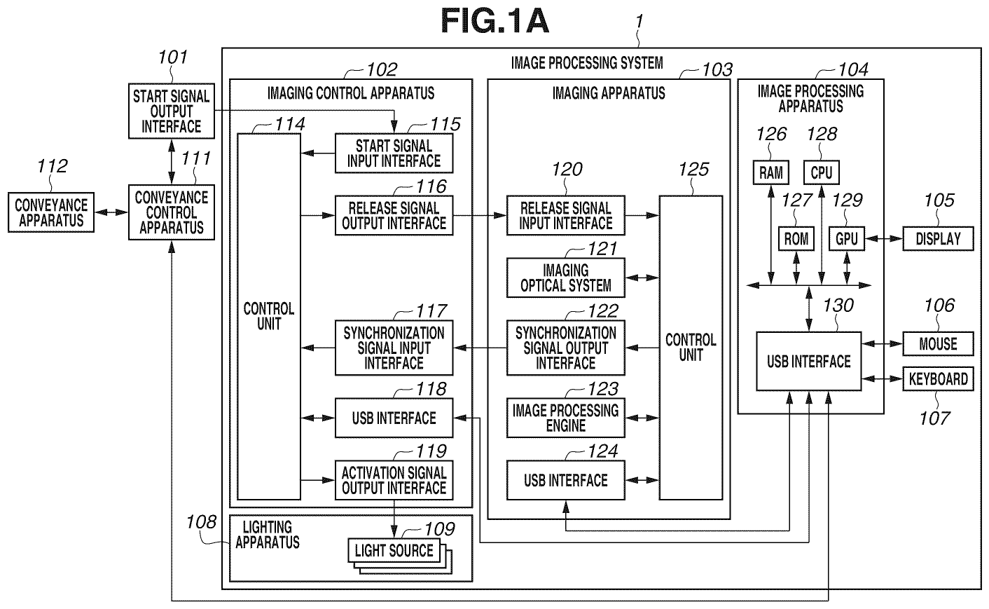

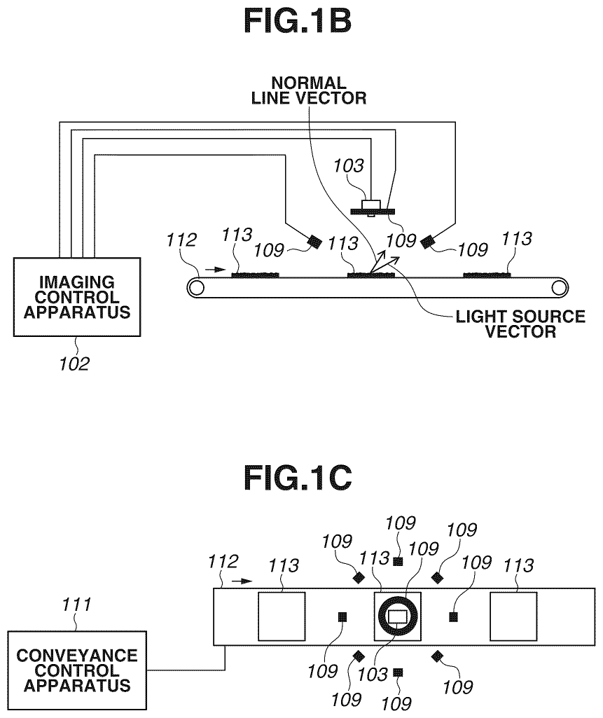

A first exemplary embodiment will be described. FIG. 1A is a diagram illustrating a hardware configuration example of an appearance inspection system according to the present exemplary embodiment. FIG. 1B is a front view of a general appearance of the appearance inspection system, and FIG. 1C is a top view of the general appearance of the appearance inspection system. The appearance inspection system in the present exemplary embodiment includes an image processing system 1, a start signal output interface 101, a conveyance control apparatus 111, and a conveyance apparatus 112.

The image processing system 1 includes an imaging control apparatus 102, an imaging apparatus 103, an image processing apparatus 104, a display 105, a mouse 106, a keyboard 107, and a lighting apparatus 108. The image processing system 1 is connected to the conveyance control apparatus 111 that controls the conveyance apparatus 112. The conveyance control apparatus 111 conveys objects 113 to be inspected to the image processing system 1 using the conveyance apparatus 112, and sends an inspection start signal to the image processing system 1 via the start signal output interface 101.

The imaging control apparatus 102 includes a control unit 114 that controls the imaging apparatus 103 and the lighting apparatus 108 to capture images of the objects 113 in synchronization with activations of light sources. In detail, upon receipt of an inspection start signal from a start signal input interface 115, the imaging control apparatus 102 issues an imaging instruction to the imaging apparatus 103 via a release signal output interface 116. The imaging control apparatus 102 also receives a synchronization signal from the imaging apparatus 103 via a synchronization signal input interface 117 to notify a light activation timing to an external strobe light source in synchronization with the imaging. Furthermore, the imaging control apparatus 102 activates the light sources of the lighting apparatus 108 in a predetermined order and combination in response to the received synchronization signals via an activation signal output interface 119. The above operation enables imaging an object 113 lit by predetermined illumination. The imaging control apparatus 102 is connected to the image processing apparatus 104 via a universal serial bus (USB) interface 118 to receive commands from the image processing apparatus 104 and to provide information indicating states of the imaging control apparatus 102 to the image processing apparatus 104.

The imaging apparatus 103 includes a control unit 125 and an imaging optical system 121 including a lens and an imaging element. The imaging apparatus 103 obtains an optical image by imaging in response to an imaging instruction received via a release signal input interface 120, and quantizes the optical image by an image processing engine 123 to generate a captured image. The imaging apparatus 103 transfers the generated captured image to the image processing apparatus 104 via a USB interface 124. While a still image is captured using a digital camera in the present exemplary embodiment as an example, a specific frame may be extracted from a moving image captured by a video camera and used as a still image.

The imaging apparatus 103 sends a synchronization signal to the imaging control apparatus 102 via a synchronization signal output interface 122.

The image processing apparatus 104 includes a random access memory (RAM) 126, a read only memory (ROM) 127, a central processing unit (CPU) 128, a graphics processing unit (GPU) 129, and a USB interface 130. These components are connected via an internal bus. Program codes of processing in a flowchart described below are stored in the ROM 127.

The program codes are loaded in the RAM 126 and executed by the CPU 128 and the GPU 129.

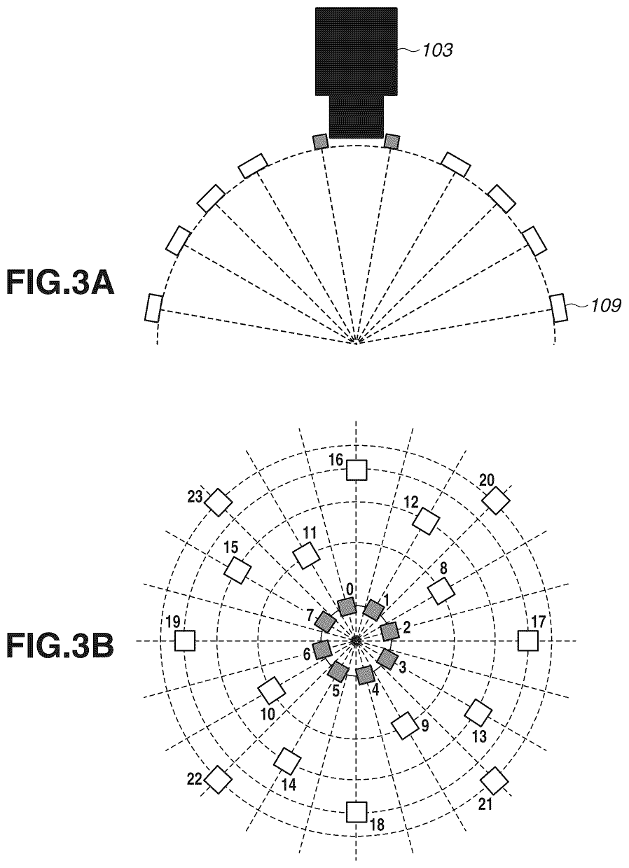

The lighting apparatus 108 includes a plurality of light sources 109. In the present exemplary embodiment, the light sources 109 are light-emitting diodes (LEDs), but can be other light sources, such as xenon lamps. FIGS. 3A and 3B illustrate an example of an arrangement of the plurality of light sources 109. FIG. 3A is a front view of the lighting apparatus 108, and FIG. 3B is a top view of the lighting apparatus 108. The light sources 109 depicted as squares are disposed in a hemispherical distribution pattern above the object 113, and are different from one another in at least one of the zenith angle and the azimuth angle. The number and arrangement of the light sources are not limited to the above example. In an inspection using captured images, the light irradiation method is changed based on the appearance inspection item. For example, in inspecting the gloss of an object, the inspection surface is irradiated with light from a direction in which specularly reflected light can be imaged. In inspecting the color or surface shape of an object, the inspection surface is irradiated with light from a direction in which specularly reflected light will not be imaged. Thus, some of the light sources 109 are disposed in directions with large angles of incidence with respect to the placement surface of the object 113, making an imaging possible under geometric conditions in which the imaging apparatus 103 easily receives diffusion reflected light. In addition, some of the light sources 109 are disposed in directions with small angles of incidence with respect to the placement surface of the object 113, making an imaging possible under geometric conditions in which the imaging apparatus 103 easily receives specularly reflected light. The light sources 109 can have different light-emitting surfaces and spectral characteristics. For example, spot illumination devices (light sources depicted as white squares in FIGS. 3A and 3B) can be installed in directions with large angles of incidence with respect to the placement surface of the object 113, and ring illumination devices (light sources depicted as gray squares in FIGS. 3A and 3B) in which light-emitting elements are arranged in a circular ring can be installed in directions with small angles of incidence. A circular ring illumination device can be used in a direction with a small angle of incidence. In response to a command from the control unit 114, the lighting apparatus 108 activates predetermined light sources of the light sources 109 for a predetermined period of time.

In the image processing system 1 of the present exemplary embodiment, the imaging control apparatus 102, the imaging apparatus 103, the image processing apparatus 104, and the lighting apparatus 108 are separate apparatuses, but two or more of those apparatuses can be integrated together.

### Processing Executed by Image Processing System

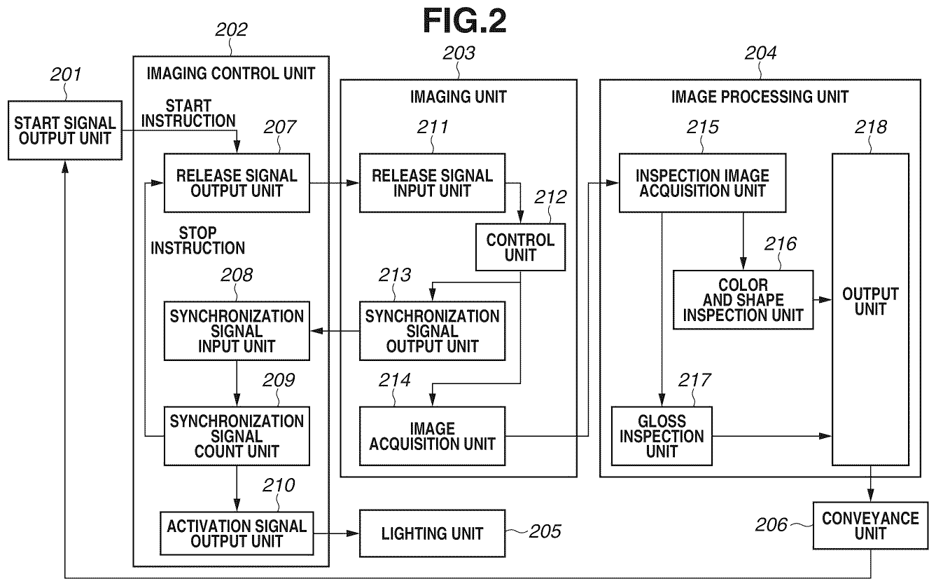

FIG. 2 is a diagram illustrating a functional configuration example of the appearance inspection system according to the present exemplary embodiment. The control unit 114 of the imaging control apparatus 102 includes an imaging control unit 202. The imaging control unit 202 includes a release signal output unit 207, a synchronization signal input unit 208, a synchronization signal count unit 209, and a light activation signal output unit 210. The control unit 125 of the imaging apparatus 103 includes an imaging unit 203. The imaging unit 203 includes a release signal input unit 211, a control unit 212, a synchronization signal output unit 213, and an image acquisition unit 214. The image processing apparatus 104 includes an image processing unit 204. The image processing unit 204 includes an inspection image acquisition unit 215, a color and shape inspection unit 216, a gloss inspection unit 217, and an output unit 218. The conveyance control apparatus 111 includes a start signal output unit 201. The conveyance apparatus 112 includes a conveyance unit 206. The lighting apparatus 108 includes a lighting unit 205.

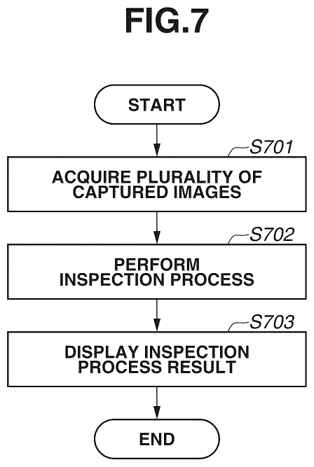

FIG. 7 is a flowchart of a process executed by the image processing system 1 in the present exemplary embodiment. When the object 113 is conveyed to a predetermined position by the conveyance apparatus 112, the start signal output unit 201 of the conveyance control apparatus 111 sends an inspection start signal to the imaging control unit 202. The process in FIG. 7 is started when the imaging control unit 202 receives the inspection start signal.

In step S701, the imaging control unit 202 and the imaging unit 203 acquire a plurality of captured images obtained by activating predetermined light sources and imaging the object 113 to be inspected, and transfer the images to the image processing unit 204. Specifically, the release signal output unit 207 that has received the inspection start signal sends a release signal to the release signal input unit 211. Upon detecting that the release signal input unit 211 receives the release signal, the control unit 212 executes an imaging operation. In the present exemplary embodiment, high-speed continuous imaging is performed using a known continuous imaging function. The continuous imaging function refers to a function that repeatedly performs imaging at a predetermined speed while the release signal is continuously sent. In the present exemplary embodiment, an imaging is performed at 30 frames per second. During imaging, the control unit 212 causes the synchronization signal output unit 213 to output a synchronization signal in order to synchronize a light activation timing of the external strobe light source with the opening of the shutter curtain. When the synchronization signal input unit 208 inputs synchronization signals, the synchronization signal count unit 209 counts the number of synchronization signals input, i.e., the number of images to be captured. The light activation signal output unit 210 switches between the light sources to be activated in sequence based on the number of images to be captured, and outputs a light activation signal to the lighting unit 205. Details of the process of controlling the light sources to be activated by the light activation signal output unit 210 will be described below. The image acquisition unit 214 repeatedly transfers as appropriate the captured images obtained by activating predetermined light sources and imaging the objects 113 to be inspected to the inspection image acquisition unit 215. The above processing allows, in step S701, the imaging control unit 202 and the imaging unit 203 to transfer the plurality of captured images to the image processing unit 204.

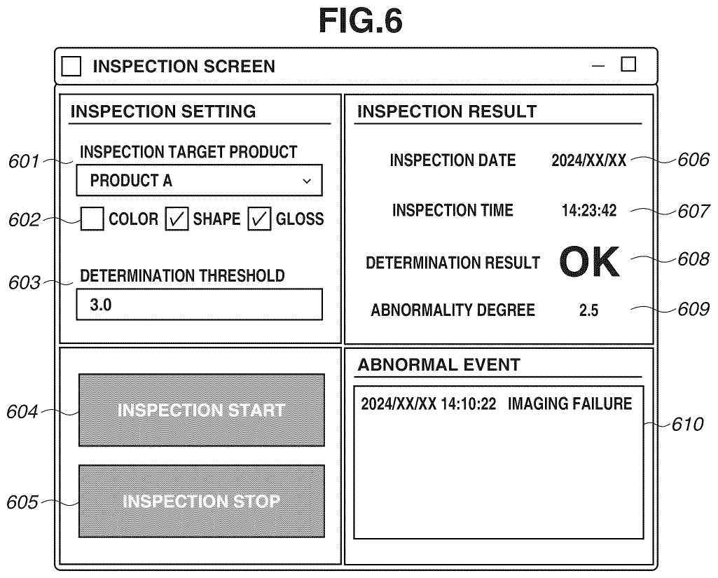

In step S702, the color and shape inspection unit 216 and the gloss inspection unit 217 perform an inspection process based on the plurality of captured images acquired by the inspection image acquisition unit 215. The color and shape inspection unit 216 performs spatial filtering on the inspection images including normal line information and color information obtained by compositing the captured images using the photometric stereo method to detect defects. A value obtained by integrating response values to the spatial filtering is defined as a degree of abnormality, and pass or fail of an inspection is determined by comparing the degree of abnormality with a determination threshold. The calculated degree of abnormality is displayed in an abnormality display area 609 of the inspection screen user interface (UI) illustrated in FIG. 6. The determination threshold can be set in a threshold setting area 603 of the inspection screen UI illustrated in FIG. 6. The gloss inspection unit 217 uses a captured image obtained by specularly reflected light from the inspection surface of the object as an inspection image with gloss information, and performs the spatial filtering in the same manner as above to detect defects. The photometric stereo method composites captured images corresponding to a plurality of lighting directions to obtain normal line information and color information representing the surface shape and the color of the object, respectively. The above inspection process method is an example, and other inspection methods can be used.

The appearance inspection items in the present exemplary embodiment come in three types: color, surface shape, and gloss. The appearance inspection items are not limited to the above example, and can include any item as long as the item represents an appearance property and is identifiable with captured images.

For example, material or pattern can be used. The inspection image acquisition unit 215 displays the inspection screen UI illustrated in FIG. 6 on the display 105 and receives instructions from a user. One or more types of appearance inspection items are set in the inspection screen UI illustrated in FIG. 6. The user can input information to the inspection screen UI displayed on the display 105 using the mouse 106 or the keyboard 107. When an inspection target product is selected from a plurality of products registered in advance in a product selection area 601 in a drop-down menu, the appearance inspection item(s) based on the selected inspection target product are set in an item setting area 602. The user can change the appearance inspection item(s) by selecting the checkbox(es) in the item setting area 602.

The inspection screen UI illustrated in FIG. 6 includes an inspection start button 604 for instructing the start of an inspection, and an inspection stop button 605 for instructing the end of an inspection. The inspection screen UI also includes an inspection date area 606 for displaying an inspection date, and an inspection time area 607 for displaying an inspection time.

In step S703, the output unit 218 displays on the display 105 a result of the inspection process. For example, on the inspection screen UI illustrated in FIG. 6, if the object passes the inspection, “OK” is displayed in the determination result area 608, and if the object does not pass the inspection, “FAILED” is displayed in the determination result area 608. An occurrence of an abnormal event, such as an imaging failure, is displayed in an abnormal event display area 610. Furthermore, the output unit 218 outputs conveyance instructions to the conveyance unit 206 to convey approved products and rejected products after the inspections to the respective subsequent steps.

### Processing for Controlling Activations of Light Sources

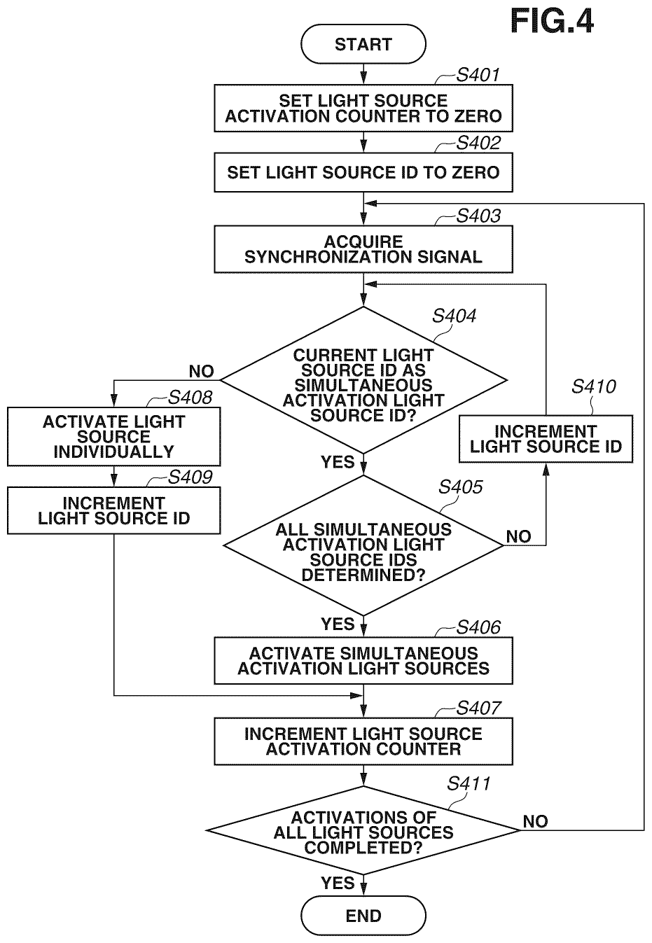

FIG. 4 is a flowchart of a process of controlling activations of the light sources by the light activation signal output unit 210. In step S401, the light activation signal output unit 210 sets a light source activation counter to zero.

The light source activation counter counts the number of times the light sources are activated, which coincides with the number of times the imaging apparatus 103 captures images of one object. In step S402, the light activation signal output unit 210 sets light source identifications (IDs), which are the identification numbers of the light sources 109, to zero. The light source IDs correspond to the numbers assigned to the light sources as described in FIG. 3.

In step S403, the light activation signal output unit 210 acquires a synchronization signal input by the synchronization signal input unit 208. In step S404, the light activation signal output unit 210 determines whether the current light source ID is a pre-set light source ID for simultaneous activations. If the light source ID is used for simultaneous activations (YES in step S404), the process proceeds to step S405. If the light source ID is not used for simultaneous activations (NO in step S404), the process proceeds to step S408. In the present exemplary embodiment, light sources with light source IDs 0 to 7 are preset as simultaneous activation light sources, but the IDs of the simultaneous activation light sources are not limited to those. The simultaneous activation light source IDs can be set by the user via a UI displayed on the display 105, or fixed IDs can be set.

In step S405, the light activation signal output unit 210 determines whether all the light source IDs set as the simultaneous activation light sources are subjected to the determination. If all the simultaneous activation light source IDs are not subjected to the determination (NO in step S405), the light activation signal output unit 210 increments the light source ID in step S410, and then the process proceeds to step S404. Steps S404, S405, and S410 are repeated, and if the light activation signal output unit 210 determines in step S405 that all the simultaneous activation light source IDs are subjected to the determination (YES in step S405), the process proceeds to step S406. In step S406, the light activation signal output unit 210 outputs a light activation signal to the lighting unit 205 for activating the light sources set as the simultaneous activation light sources. Upon receipt of the light activation signal, the lighting unit 205 activates the simultaneous activation light sources. In the present exemplary embodiment, the lighting unit 205 activates the light sources with light source IDs 0 to 7.

If it is determined in step S404 that the current light source ID is not a simultaneous activation light source ID (NO in step S404), in step S408, the light activation signal output unit 210 outputs a light activation signal to the lighting unit 205 for activating the light source with an ID that corresponds to the current light source ID. Upon receipt of the light activation signal, the lighting unit 205 activates the light source with an ID that corresponds to the current light source ID. In step S409, the light activation signal output unit 210 increments the light source ID. In step S407, the light activation signal output unit 210 increments the light source activation counter since one or more light sources are activated in step S406 or step S409. In step S411, the light activation signal output unit 210 determines whether the activations of all the light sources are completed. If not (NO in step S411), the process returns to step S403. If completed (YES in step S411), the process illustrated in FIG. 4 ends.

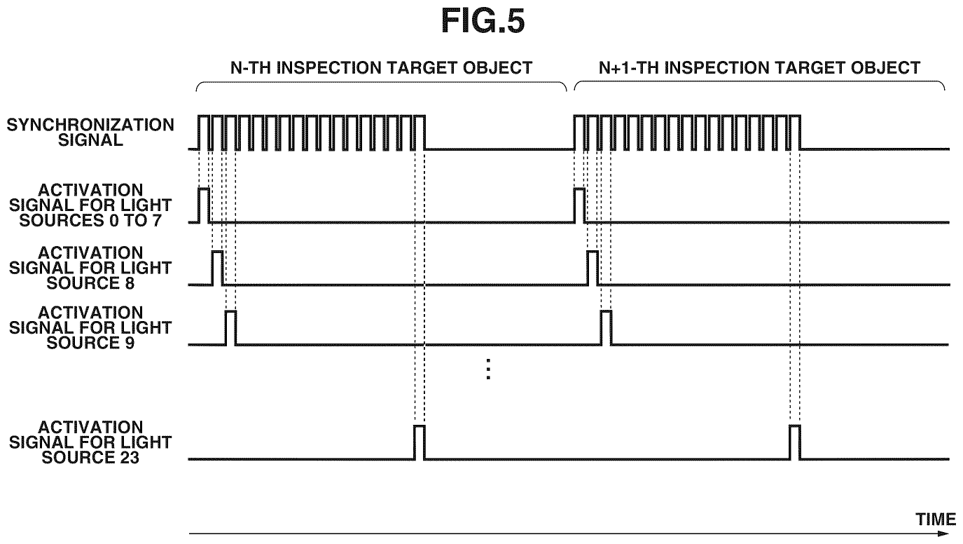

With the above-described process, the light sources are activated for imaging each of the inspection target objects 113 for a preset number of images. FIG. 5 illustrates the correspondence between the synchronization signals acquired by the light activation signal output unit 210 and light activation signals generated based on preset light activation times. The light activation signals for the light sources are generated by the process in the flowchart illustrated in FIG. 4, and eight of the 24 light sources are activated simultaneously, and the imaging of one inspection target object is completed with a total of 17 light activations, i.e., with a total of 17 imaging capturing operations. The method of simultaneously activating the light sources is not limited to the above-described example. For example, if a change of the simultaneous activation light sources is not planned, the light sources with light source IDs 0 to 7 in the lighting apparatus 108 can be electrically connected, and the lighting apparatus 108 can include one signal terminal that inputs signals to that light source group. Connecting light sources that consume high amounts of power involves increasing the electrical capacity of the lighting apparatus 108. In addition, there is a possibility that the pixel value of the captured image may level off due to the increased brightness from simultaneous activation of the light sources. Thus, light sources with a relatively low amount of power consumed are used for the simultaneous activation light sources.

In the present exemplary embodiment, if the appearance inspection items include color, color information obtained by compositing 16 images captured in synchronization with activations of the light sources 8 to 23, which have relatively large zenith angles, is an inspection image. If the appearance inspection item is color alone, one image captured in synchronization with a light activation of one of the light sources 8 to 23, which has less influence of specular reflection, can be used as an inspection image. For example, through averaging the pixel values of the images captured in synchronization with activations of the light sources 8 to 11, the obtained average image can be as an inspection image. Similar to the light sources 0 to 7 in the above example, one image captured by simultaneously activating the light sources 8 to 11 can be used as an inspection image.

In the present exemplary embodiment, if the appearance inspection item is surface shape, normal line information obtained by compositing 16 images captured in synchronization with activations of the light sources 8 to 23, which have relatively large zenith angles, is an inspection image. In the present exemplary embodiment, if the appearance inspection item is gloss, an image obtained by capturing light specularly reflected from the inspection surface is an inspection image. Specifically, one image captured in synchronization with activations of the light sources 0 to 7, which have relatively small zenith angles, is an inspection image for gloss inspection.

The color and shape inspection unit 216 and the gloss inspection unit 217 can extract and inspect a predetermined area on the inspection surface of the object 113. For example, the color and shape inspection unit 216 and the gloss inspection unit 217 extract an area set in advance by a user as the inspection target area. Some three-dimensional shapes of industrial products can cause shadow areas in inspection targets in captured images corresponding to light irradiation from light sources with relatively large zenith angles. In this case, use of a captured image corresponding to light irradiation from light sources with relatively small zenith angles makes it possible to extract an inspection target area under conditions in which the shadow area is reduced, improving the inspection accuracy.

The inspection screen UI illustrated in FIG. 6 can be provided with an area where the user can select a light source ID to be activated. In this case, a warning message can be displayed when the light source ID selected by the user is not suitable for color, surface shape, and gloss selected in the item setting area 602. If the inspection target has a relatively matte surface, an image for gloss inspection can be captured using light sources with large zenith angles, so that the user can select simultaneous activations of the light sources with the light source IDs 8 to 11 as light sources for the gloss inspection.

A second exemplary embodiment will now be described. In the first exemplary embodiment, simultaneous activations and individual sequential activations of the light sources are controlled based on synchronization signals output from the imaging apparatus 103. In the present exemplary embodiment, a synchronous imaging is performed by simultaneously issuing an imaging instruction to the imaging apparatus 103 and a light activation instruction to the lighting apparatus 108 with pulse signals output from the control unit 114. The following description will focus on a difference between the present exemplary embodiment and the first exemplary embodiment. The same components as those in the first exemplary embodiment will be described with the same reference numerals.

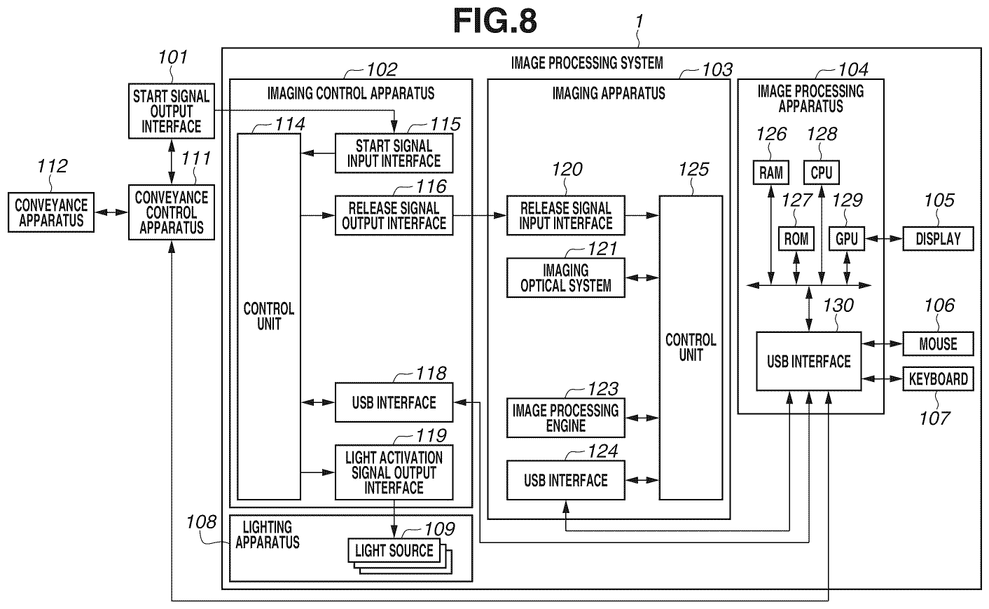

FIG. 8 is a diagram illustrating a hardware configuration example of an appearance inspection system according to the present exemplary embodiment.

In an image processing system 1 of the present exemplary embodiment, the imaging apparatus 103 does not include the synchronization signal output interface 122, and an imaging control apparatus 102 does not include the synchronization signal input interface 117. The other parts of the hardware configuration are the same as those in the first exemplary embodiment.

### Processing Executed by Image Processing System

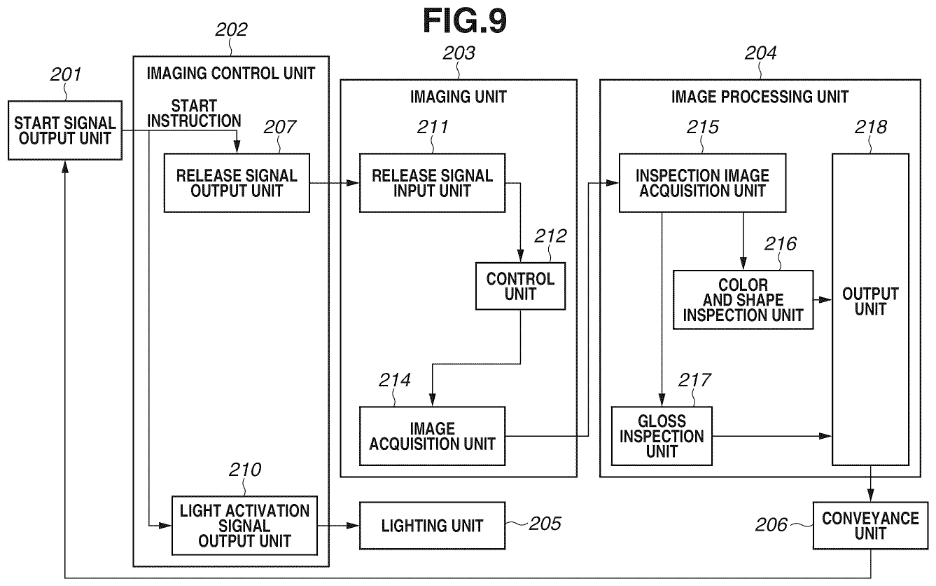

FIG. 9 is a diagram illustrating a functional configuration example of the appearance inspection system in the present exemplary embodiment. In the image processing system 1 in the present exemplary embodiment, the imaging unit 203 does not include the synchronization signal output unit 213, and the imaging control unit 202 does not include the synchronization signal input unit 208 or the synchronization signal count unit 209. The other parts of the functional configuration are the same as those in the first exemplary embodiment.

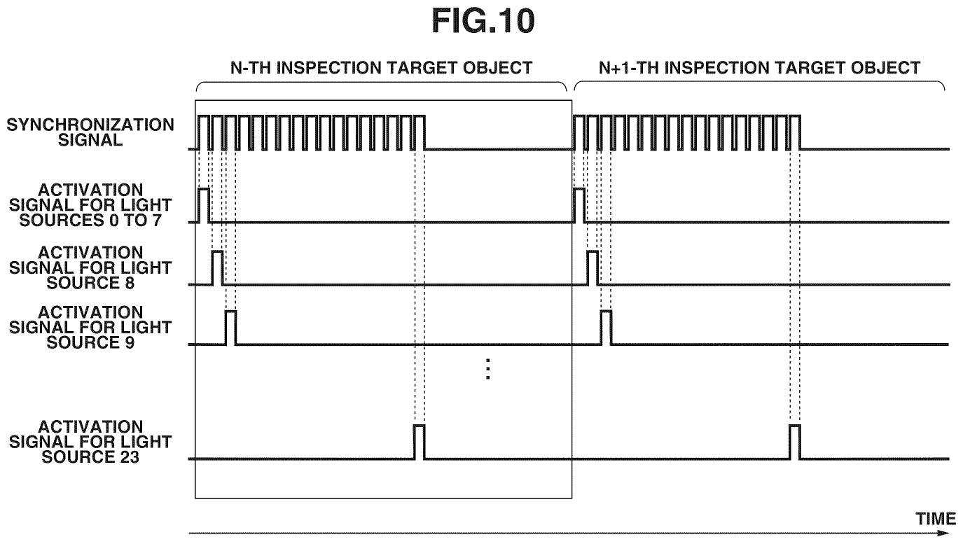

The processing executed by the image processing system 1 in the present exemplary embodiment will be described with reference to the flowchart in FIG. 7. In step S701, the imaging control unit 202 and the imaging unit 203 acquire a plurality of captured images obtained by activating predetermined light sources and imaging an inspection target object 113, and transfer the captured images to an image processing unit 204. Specifically, upon receipt of an inspection start signal, the control unit 114 transmits a pulse signal to a release signal output unit 207, as well as to a light activation signal output unit 210. FIG. 10 illustrates an example of pulse signals transmitted by the control unit 114. The pulse signals framed in lines illustrated in FIG. 10 have pre-set signal waveforms. At the timing when the start signal output unit 201 notifies the start of an inspection, the release signal output unit 207 transmits synchronization signals framed in lines to a release signal input unit 211 of the imaging unit 203, and the imaging unit 203 performs an imaging. At the same time, the light activation signal output unit 210 transmits light source activation signals framed in lines to a lighting unit 205 to start activations of light sources 109. This method enables imaging synchronized with the activations of the light sources 109, and as illustrated in FIG. 10, simultaneous light activations can be controlled by sending signals having the same waveform to light sources with IDs to be activated simultaneously.

As described above, use of the appearance inspection systems of the above-described exemplary embodiments makes it possible to simultaneously inspect the color, surface shape, and gloss of an inspection target object. In addition, activating a plurality of light sources 109 by the lighting apparatus 108 at approximately the same timing during one image capture makes it possible to reduce the number of images captured and shorten the imaging time and the time taken for the inspection process.

According to embodiments of the present disclosure, the time taken for an inspection based on captured images obtained by imaging an object can be reduced.

Embodiment(s) of the present disclosure can also be realized by a computer of a system or apparatus that reads out and executes computer-executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer-executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer-executable instructions. The computer-executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc™ (BD)), a flash memory device, a memory card, and the like.

While the present disclosure has described exemplary embodiments, it is to be understood that some embodiments are not limited to the disclosed exemplary embodiments. The scope of the following claims is to be accorded the broadest interpretation so as to encompass all such modifications and equivalent structures and functions.

This application claims priority to Japanese Patent Application No. 2024-044104, which was filed on Mar. 19, 2024 and which is hereby incorporated by reference herein in its entirety.

What is claimed is:

1. A control apparatus comprising:
at least one processor; and
at least one memory that is in communication with the at least one processor, wherein the at least one memory stores instructions for causing the at least one processor and the at least one memory to:
acquire a first signal indicating activation timings of light sources synchronized with an imaging;
activate a plurality of light sources among the activation timings of the light sources based on the first signal at a first timing; and
output, to a lighting unit, a second signal for activating a light source different from the plurality of light sources at a second timing.

2. The control apparatus according to claim 1, wherein the at least one memory further stores instructions for causing the at least one processor and the at least one memory to: activate the plurality of light sources at the first timing, and output, to the lighting unit, the second signal for activating the light source different from the plurality of light sources at the second timing.

3. The control apparatus according to claim 1, wherein the at least one memory further stores instructions for causing the at least one processor and the at least one memory to use a captured image obtained by imaging an object irradiated with light from the plurality of light sources activated at the first timing to inspect a gloss of the object.

4. The control apparatus according to claim 1, wherein the at least one memory further stores instructions for causing the at least one processor and the at least one memory to use a captured image obtained by imaging an object irradiated with light from the light source activated at the second timing, the light source being different from the plurality of light sources, to inspect a color of the object.

5. The control apparatus according to claim 1, wherein the at least one memory further stores instructions for causing the at least one processor and the at least one memory to use a captured image obtained by imaging an object irradiated with light from the light source activated at the second timing, the light source being different from the plurality of light sources, to inspect a surface shape of the object.

6. The control apparatus according to claim 1,
wherein the lighting unit includes light sources disposed in a hemispherical distribution pattern above an object as an inspection target, and
wherein the plurality of light sources activated at the first timing is smaller in zenith angle than the light source activated at the second timing, the light source being different from the plurality of light sources.

7. The control apparatus according to claim 1, wherein the plurality of light sources activated at the first timing is selected based on an instruction from a user.

8. The control apparatus according to claim 1, wherein
the plurality of light sources activated at the first timing are electrically connected to each other, and
the lighting unit includes one signal terminal from which a signal is inputtable to the plurality of light sources.

9. The control apparatus according to claim 1, wherein the plurality of light sources activated at the first timing are smaller in amount of power consumed than the light source activated at the second timing, different from the plurality of light sources.

10. A control method comprising:
acquiring a first signal indicating activation timings of light sources synchronized with an imaging;
activating a plurality of light sources at a first timing among the activation timings of the light sources based on the first signal; and
outputting, to a lighting unit, a second signal for activating a light source different from the plurality of light sources at a second timing.

11. A non-transitory computer-readable storage medium storing instructions that, when executed by a computer, cause the computer to perform a control method, the control method comprising:
acquiring a first signal indicating activation timings of light sources synchronized with an imaging;
activating a plurality of light sources at a first timing among the activation timings of the light sources based on the first signal; and
outputting, to a lighting unit, a second signal for activating a light source different from the plurality of light sources at a second timing.
